(19) United States
(12) Patent Application Publication
(10) Pub. No.: US 2010/0085337 A1
(43) Pub. Date: Apr. 8, 2010

(54) PLASMA DISPLAY PANEL

(76) Inventor: Takashi Sasaki, Hiratsuka (JP)

Correspondence Address: MCDERMOTT WILL & EMERY LLP, 600 13TH STREET, N.W., WASHINGTON, DC, 20005-3096, US

(21) Appl. No.: 12/598,379

(22) PCT Filed: May 25, 2007
(86) PCT No.: PCT/JP2007/000563

§ 371 Date: Oct. 30, 2009

(51) Int. Cl. G09G 3/28; G06F 3/038

(52) U.S. Cl. 345/205; 345/60

(57) ABSTRACT

A plasma display panel has a first plate and a second plate facing each other. An image display area of the plasma display panel is made up of cells emitting light by a discharge. A plurality of first electrodes extending in a first direction and disposed at intervals and a first dielectric layer covering the display area of the first electrodes are provided on the first plate. In addition, a plurality of second electrodes extending in a second direction orthogonal to the first direction and disposed at intervals are provided on the first dielectric layer. Further, a seal material is disposed in the shape of a frame, in order to adhere the second plate to the first plate, at a position more inside than an edge part of the first dielectric layer on an outer surround part of the display area on the second plate.

### CROSS-REFERENCE TO RELATED APPLICATION

This application is a U.S. National Stage application claiming the benefit of prior filed International Application Number PCT/JP2007/000563, filed May 25, 2007, the entire contents of which are incorporated herein by reference.

### TECHNICAL FIELD

The present invention relates to a plasma display panel used for a display device.

### BACKGROUND ART

A plasma display panel (PDP) has two glass plates adhered to each other and displays an image by emitting discharge light in a space formed between the glass plates. Cells corresponding to pixels in an image are self-luminescence ones, which are coated with phosphors which emit visible lights of red, green, and blue under ultraviolet rays generated by discharge.

For example, a PDP having a 3-electrode structure displays an image by generating sustain discharge between an X-electrode and a Y-electrode. A cell (cell to be lit) to generate the sustain discharge is selected, for example, by selectively generating address discharge between the Y-electrode and an address electrode.

In a general PDP, the X-electrode and the Y-electrode are disposed on a front glass plate, and address electrodes are disposed on a back glass plate. Furthermore, in recent years, a PDP in which three kinds of electrodes of the X-electrode, the Y-electrode, and the address electrodes are disposed on a front glass plate has been proposed (see Patent Document 1, for example). In a PDP of this type, first-layer electrodes such as the X-electrode and the Y-electrode are formed on a glass base, and second-layer electrodes such as address electrodes which are orthogonal to an extension direction of the first-layer electrodes are formed on a dielectric layer covering the first-layer electrodes. The front glass plate includes the glass base and the dielectric layer formed on the glass base.
Patent Document 1: Japanese Unexamined Patent Application Publication No. H10-321145

### DISCLOSURE

### Problems to be Solved

In a PDP, seal material for adhering a front glass plate to a back glass plate is disposed on an outer surround part of an image display area. For example, in a PDP having address electrodes on a back glass plate, extracting portions of X electrodes and Y electrodes are provided on two sides of a front glass plate, and no extracting portion of the electrodes is provided on the other two sides. For this reason, the seal material is disposed inside by a predetermined distance (extracting portions) from the edge part of the front glass plate on two sides where the extracting portions of the electrodes are provided, and is disposed in the vicinity of the edge part of the front glass plate on the other two sides to prevent the area of the PDP from increasing.

In contrast to this, in a PDP having address electrodes on a front glass plate, for example, the extracting portions of X electrodes and Y electrodes are provided on two sides of the front glass plate, and the extracting portions of the address electrodes are provided on the other two sides. For this reason, seal material is disposed inside by a predetermined distance (extracting portions) from the edge part of the front glass plate on the four sides where the extracting portions of the electrodes are provided.

For example, when seal material is disposed crossing over the edge part of a dielectric layer covering first-layer electrodes such as X electrodes and Y electrodes, a joint portion between the front glass plate and the back glass plate (joint portion of the seal material) has a step between the dielectric layer and the front glass base. In this case, a gap may appear in the step of the joint portion of the seal material, the atmosphere may gradually enter the PDP from the gap, and the PDP may not operate. That is, when the step of the joint portion of the seal material is large, the airtightness of the PDP deteriorates and the reliability of the PDP decreases. However, for a PDP having electrodes orthogonal to each other on a front glass plate, no invention concerning a positional relation between the front glass plate and the seal material, especially a positional relation between the dielectric layer of the front glass plate and the seal material, has been proposed.

A proposition of the present invention is to secure the airtightness of a PDP having electrodes orthogonal to each other on a front glass plate and prevent the reliability of the PDP from decreasing. In particular, a proposition of the present invention is to secure the airtightness of the PDP and prevent the reliability of the PDP from decreasing while preventing the work of connection between each of the electrodes and a driver circuit from becoming complicated.

### Means for Solving the Problems

A plasma display panel has a first plate and a second plate facing each other. An image display area of the plasma display panel is made up of cells emitting light by a discharge. A plurality of first electrodes extending in a first direction and disposed at intervals and a first dielectric layer covering the display area of the first electrodes are provided on the first plate. In addition, a plurality of second electrodes extending in a second direction orthogonal to the first direction and disposed at intervals are provided on the first dielectric layer.

Further, a seal material is disposed in the shape of a frame, in order to adhere the second plate to the first plate, at a position more inside than an edge part of the first dielectric layer on an outer surround part of the display area on the second plate.

### Effect

The present invention is able to secure the airtightness of a PDP having electrodes orthogonal to each other on a front glass plate and prevent the reliability of the PDP from decreasing. In particular, the present invention is able to secure the airtightness of the PDP and prevent the reliability of the PDP from decreasing while preventing the work of connection between each of the electrodes and a driver circuit from becoming complicated.

### BRIEF DESCRIPTION OF THE DRAWINGS

FIG. 1 is an exploded perspective view of the principal part of a PDP according to the first embodiment of the present invention.

FIG. 2 is an explanatory diagram of the PDP shown in FIG. 1.

FIG. 3 is a cross-sectional view taken along the line A-A′ of the PDP shown in FIG. 2.

FIG. 4 is a cross-sectional view taken along the line B-B′ of the PDP shown in FIG. 2.

FIG. 5 is an exploded perspective view showing an example of a plasma display device made up using the PDP shown in FIG. 1.

FIG. 6 is a block diagram showing the outline of the circuit unit shown in FIG. 5.

FIG. 7 is a waveform chart showing an example of discharge operation of a subfield for displaying an image on the PDP shown in FIG. 1.

FIG. 8 is an explanatory diagram of a PDP according to the second embodiment of the present invention.

FIG. 9 is a cross-sectional view taken along the line A-A′ of the PDP shown in FIG. 8.

FIG. 10 is a cross-sectional view taken along the line B-B′ of the PDP shown in FIG. 8.

FIG. 11 is a cross-sectional view of a PDP according to the third embodiment of the present invention.

FIG. 12 shows a cross section orthogonal to the cross section of the PDP shown in FIG. 11.

FIG. 13 is an explanatory diagram showing the outline of the back plate part shown in FIG. 11.

FIG. 14 is an explanatory diagram showing the outline of the back plate part of a PDP according to a variation of the present invention.

FIG. 15 is an explanatory diagram showing the electrode configuration of a PDP according to another variation of the present invention.

### DETAILED DESCRIPTION OF THE EMBODIMENTS

Embodiments of the present invention will be described below using the drawings.

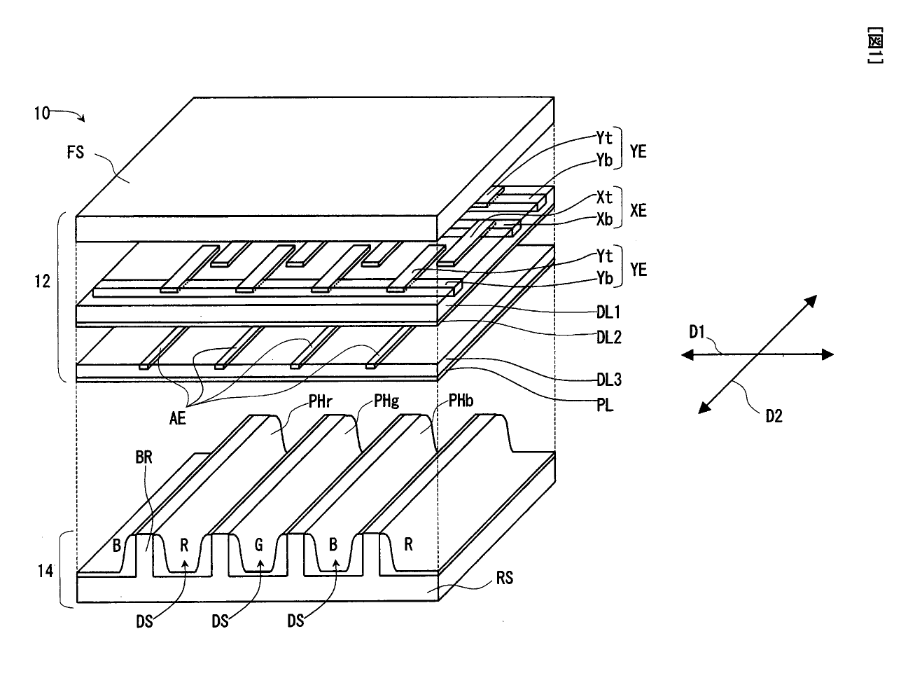

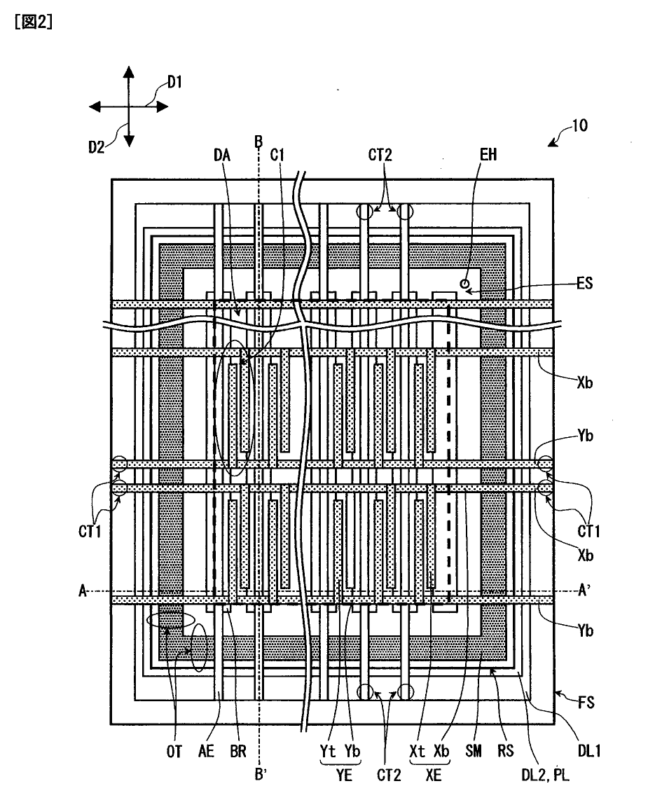

FIG. 1 shows the first embodiment of the present invention. FIG. 1 is an exploded perspective view showing the principal part of a plasma display panel (also referred to as a PDP hereinafter) in an image display area (area surrounded by a thick broken line in FIG. 2 described later). An arrow D1 in the figure indicates a first direction D1, and an arrow D2 indicates a second direction D2 which is orthogonal to the first direction D1 in a plane parallel to an image display surface. A PDP 10 has a front plate part 12 making up the image display surface and a back plate part 14 facing the front plate part 12. Discharge spaces DS are formed between the front plate part 12 and the back plate part 14 (in concave portions of the back plate part 14 in more detail).

The front plate part 12 has X bus electrodes Xb and Y bus electrodes Yb which are formed in parallel along the first direction D1 and formed alternately along the second direction D2 on a glass base FS (first plate) (on the underside of it in the figure) in order to generate discharge repeatedly. An X transparent electrode Xt extending in the second direction D2 from the X bus electrode Xb toward the Y bus electrode Yb is coupled with the X bus electrode Xb. Furthermore, a Y transparent electrode Yt extending in the second direction D2 from the Y bus electrode Yb toward the X bus electrode Xb is coupled with the Y bus electrode Yb. In other words, the X transparent electrode Xt and the Y transparent electrode Yt face each other along the second direction D2.

The X bus electrodes Xb and the Y bus electrodes Yb are opaque electrodes made of metal material or the like, and the X transparent electrodes Xt and the Y transparent electrodes Yt are transparent electrodes which are made of ITO film or the like and transmit light. The transparent electrodes Xt and Yt may be disposed in the whole area between the glass base FS and the bus electrodes Xb and Yb which are in contact with the transparent electrodes Xt and Yt respectively. Furthermore, the transparent electrodes Xt and Yt may be made of the same material (metal material or the like) as that of the bus electrodes Xb and Yb integrally with the bus electrodes Xb and Yb. An X electrode XE (sustain electrode, one kind of first electrodes) includes the X bus electrode Xb and the X transparent electrode Xt, and a Y electrode YE (scan electrode, one kind of first electrodes) include the Y bus electrode Yb and the Y transparent electrode Yt.

The electrodes Xb, Xt, Yb, and Yt are covered with a dielectric layer DL1. For example, the dielectric layer DL1 is a silicon dioxide film (film of SiO₂, film of silicon dioxide) formed by a CVD method. A plurality of address electrodes AE (second electrodes) extending in a direction (second direction D2) orthogonal to the bus electrodes Xb and Yb are provided on the dielectric layer DL1 (on the underside of it in the figure). The address electrodes AE are covered with a dielectric layer DL2, and a surface of the dielectric layer DL2 is covered with a protective layer PL of MgO or the like.

A back plate part 14 facing the front plate part 12 through discharge spaces DS has barrier ribs BR formed in parallel with each other on a glass base RS (second plate). The barrier ribs BR extend in a direction (second direction D2) orthogonal to the bus electrodes Xb and Yb and face the address electrodes AE. In other words, the address electrodes AE are disposed in positions facing the barrier ribs BR. The barrier ribs BR make up the side walls of cells. In addition, phosphors PHr, PHg, and PHb, which emit visible lights of red (R), green (G), and blue (B), respectively, when excited by ultraviolet rays, are coated on the sides of the barrier ribs BR and on the glass base RS between the barrier ribs BR adjacent to each other.

One pixel of the PDP 10 is made up of three cells emitting red, green, and blue light. One cell (a pixel of one color) is formed in an area defined by bus electrodes Xb and Yb and barrier ribs BR. Like this, the PDP 10 has cells disposed in a matrix to display an image and two or more kinds of cells emitting light of colors different from each other arranged alternately. In other words, the image display area (area surrounded by a thick broken line in FIG. 2 described later) is made up of cells disposed in a matrix state. Cells formed along the bus electrodes Xb and Yb make up display lines, which is not particularly shown in the figure.

The PDP 10 is made up by adhering the front plate part 12 and the back plate part 14 to each other so that the protective layer PL and the barrier ribs BR come into contact with each other and encapsulating the discharge spaces DS with discharge gas such as Ne or Xe.

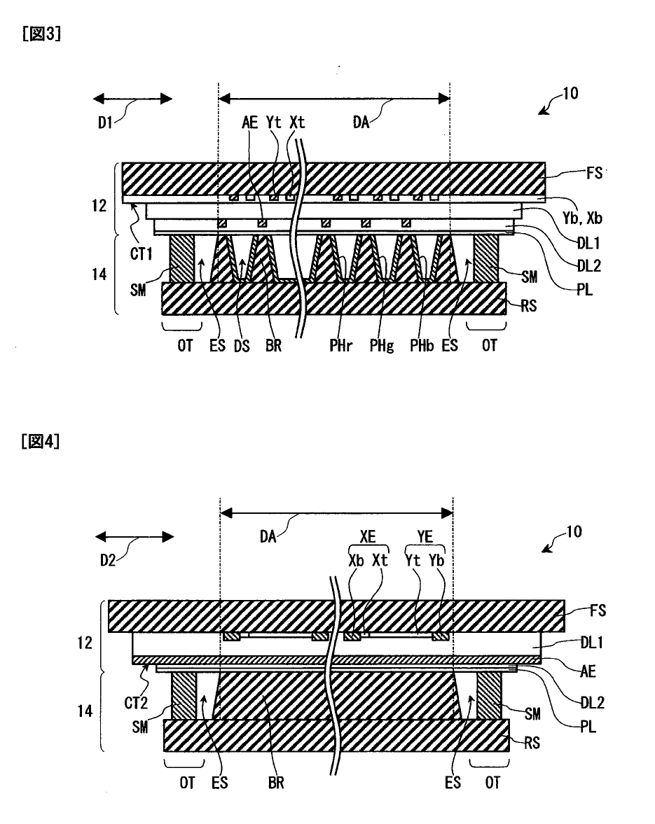

FIG. 2 shows the outline of the PDP 10 shown in FIG. 1. FIG. 2 shows a state viewed from the image display surface side (topside in FIG. 3 described later). A dark shaded portion (portion shaped like a frame) in FIG. 2 shows seal material SM. Furthermore, light shaded portions (shaded portions excluding the portion shaped like a frame) in FIG. 2 show the sustain electrodes XE (bus electrodes Xb and transparent electrodes Xt) and the scan electrodes YE (bus electrodes Yb and transparent electrodes Yt). As described above, the image display area DA (area surrounded by a thick broken line in the figure) is made up of cells C1 disposed in a matrix state.

The seal material SM is disposed on an outer surround part OT outside the display area DA of the glass base RS. For example, the seal material SM is made of low-melting glass, and adheres the front plate part 12 to the back plate part 14. The seal material SM is disposed inside the protective layer PL and the dielectric layer DL2, which are disposed inside the dielectric layer DL1. Furthermore, the glass base RS is disposed inside the protective layer PL and the dielectric layer DL2.

An exhaust hole EH extending to the outer surface of the glass base RS is provided in an exhaust space ES formed between the seal material SM and the barrier ribs BR. Because of this, the discharge spaces DS (concave portions of the back plate part 14 shown in FIG. 1 described above) of the assembled PDP 10 can be set to a vacuum state, and discharge gas can be encapsulated in the discharge spaces DS.

In this example, when viewed from the image display surface side, the address electrodes AE are provided in positions overlapping the barrier ribs BR, and the transparent electrodes Yt face address electrodes AE corresponding to themselves (positioned at the left of themselves in the figure).

For this reason, address discharge can be generated in the discharge space DS of the cell C1 to which attention is paid by applying a voltage between an address electrode AE and a transparent electrode Yt. At this time, barrier ribs BR also act as part of the dielectric layer, and an electric field between the address electrode AE and the transparent electrode Yt is generated in the discharge space DS.

Furthermore, the transparent electrodes Xt and Yt disposed along the first direction D1 are alternately arranged. Thus, in cells C1 adjacent to each other in the first direction D1 with an address electrode AE in between, the transparent electrodes Yt of both of the cells C1 are not adjacent to both sides of one address electrode AE. For this reason, when address discharge is generated between the address electrode AE and the transparent electrode Yt of the cell C1 to which attention is paid (in an address period), erroneous discharge can be prevented from occurring in the adjacent cell C1.

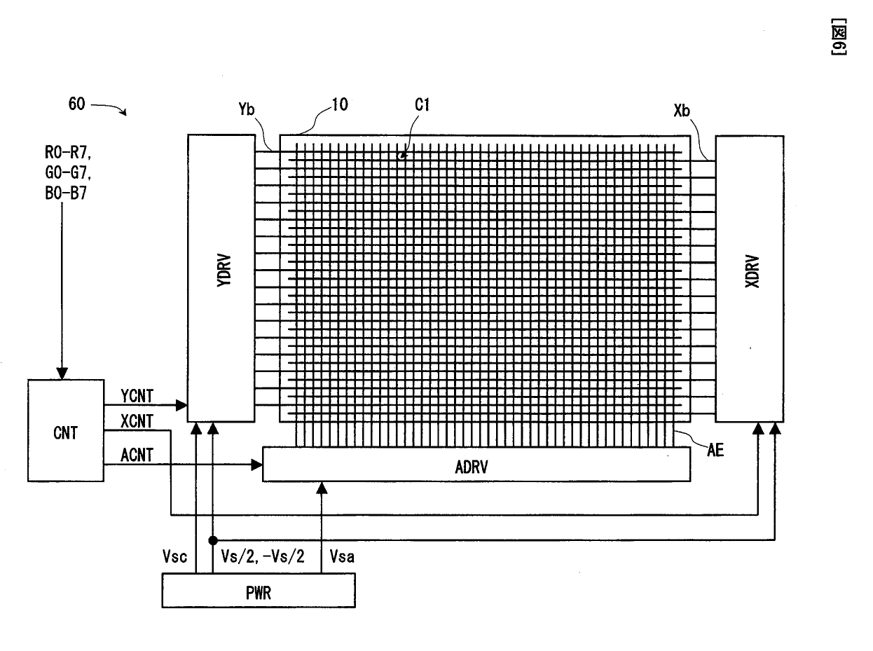

End parts of the bus electrodes Xb and Yb are positioned on the edge part of the glass base FS of the front plate part 12 and function as connection parts CT1 to couple with circuits applying a voltage to the electrodes XE and YE, respectively. Furthermore, end parts of the address electrodes AE are positioned between the edge part of the dielectric layer DL1 and the edge part of the dielectric layer DL2 and function as connection parts CT2 to couple with a circuit applying a voltage to the address electrodes AE. The circuits applying a voltage to the electrodes XE, YE and AE are, for example, drivers XDRV, YDRV and ADRV shown in FIG. 6 described later.

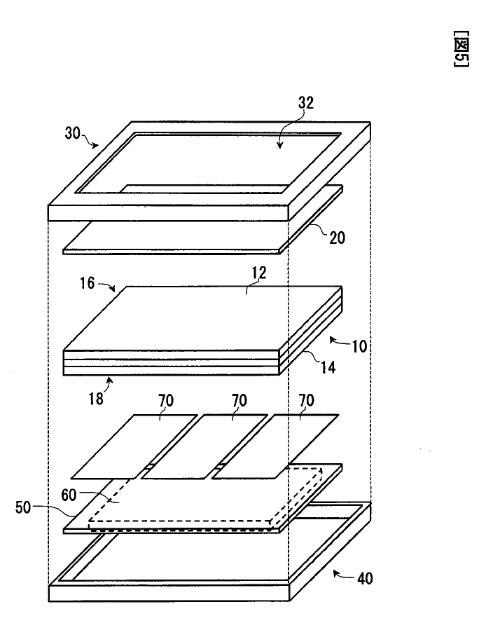

FIGS. 3 and 4 show a cross section of the PDP 10 shown in FIG. 2. FIG. 3 shows a cross section taken along the line A-A′ in FIG. 2, and FIG. 4 shows a cross section taken along the line B-B′ in FIG. 2.

As shown in FIGS. 3 and 4, the seal material SM is disposed between the outer surround part OT of the glass base RS of the back plate part 14 and the protective layer PL of the front plate part 12 and is joined to each of them, thereby adhering the front plate part 12 and the back plate part 14 together. For this reason, steps between the dielectric layers DL1 and DL2 and the glass base FS are positioned outside the seal material SM. That is, any step can be prevented from appearing in the joint portion of the seal material SM.

For example, if any step has appeared in the joint portion of the seal material SM, a gap may appear in the step, the atmosphere may gradually enter the PDP from the gap, and the PDP may not operate. That is, if any gap has appeared in the step of the joint portion of the seal material SM, the airtightness of the PDP 10 deteriorates and the reliability of the PDP 10 decreases. In this embodiment, any step can be prevented from appearing in the joint portion of the seal material SM, so that the airtightness of the PDP 10 can be prevented from deteriorating and the reliability of the PDP 10 can be prevented from decreasing.

Furthermore, as shown in FIG. 3, the edge part of the glass base RS is positioned more inside than the edge part of the dielectric layer DL1. Because of this, a work space in which there is no obstacle (e.g. the glass base RS) can be secured on the connection parts CT1. As a result of this, for example, the drivers XDRV and YDRV shown in FIG. 6 described later can be easily coupled to the connection parts CT1.

As shown in FIG. 4, the connection parts CT2 of the address electrodes AE are disposed outside the seal material SM and provided on a plane of the dielectric layer DL1. In this embodiment, the seal material SM is disposed inside the dielectric layer DL1, so that the connection parts CT2 can be easily formed on a plane of the dielectric layer DL1. For example, the address electrodes AE having the connection parts CT2 are easily formed with a general manufacturing process forming an electrode pattern using an exposure process after depositing metal microspheres on a surface of the dielectric layer DL1 by a sputtering method or a vapor deposition method. Furthermore, the edge part of the glass base RS is positioned more inside than the edge part of the dielectric layer DL2. Because of this, a work space in which there is no obstacle (e.g. the glass base RS) can be secured on the connection parts CT2. As a result of this, for example, the driver ADRV shown in FIG. 6 described later can be easily coupled to the connection parts CT2.

FIG. 5 shows an example of a plasma display device made up using the PDP shown in FIG. 1. A plasma display device (also referred to as a PDP device hereinafter) has the PDP 10, an optical filter 20 provided on the image display surface 16 side (light output side) of the PDP 10, a front case 30 disposed on the image display surface 16 side of the PDP 10, a rear case 40 and a base chassis 50 which are disposed on a rear surface 18 side of the PDP 10, a circuit unit 60 attached on the rear case 40 side of the base chassis 50 for driving the PDP 10, and a double-faced adhesive sheet 70 for adhering the PDP 10 to the base chassis 50. The circuit unit 60 is made up of two or more parts and is therefore shown with a broken line box in the figure. An optical filter 20 is adhered to a protection glass (not shown) which is attached to an opening part 32 of the front case 30. The optical filter 20 may have an electromagnetic wave shielding function. Furthermore, the optical filter 20 may be directly adhered not to the protection glass but to the image display surface 16 side of the PDP 10.

FIG. 6 shows the outline of a circuit unit 60 shown in FIG. 5. The circuit unit 60 has an X driver XDRV applying a common pulse to the bus electrodes Xb, a Y driver YDRV selectively applying a pulse to the bus electrodes Yb, an address driver ADRV selectively applying a pulse to the address electrodes AE, a control unit CNT controlling the operations of the drivers XDRV, YDRV, and ADRV, and a power-supply unit PWR. The drivers XDRV, YDRV, and ADRV operate as a driver unit driving the PDP 10. The power-supply unit PWR generates power supply voltages Vsc, Vs/2, −Vs/2, Vsa, etc. supplied to the drivers YDRV, XDRV, and ADRV.

The control unit CNT selects a subfield used based on image data R0-7, G0-7, and B0-7, and outputs control signals YCNT, XCNT, and ACNT to the drivers YDRV, XDRV, and ADRV. Subfields are obtained by dividing one field for displaying one screen of the PDP 10, and the number of times of sustain discharge has been set for each subfield. Then, a multiple gradation image is displayed by selecting the subfield used for each of cells C1 constituting pixels.

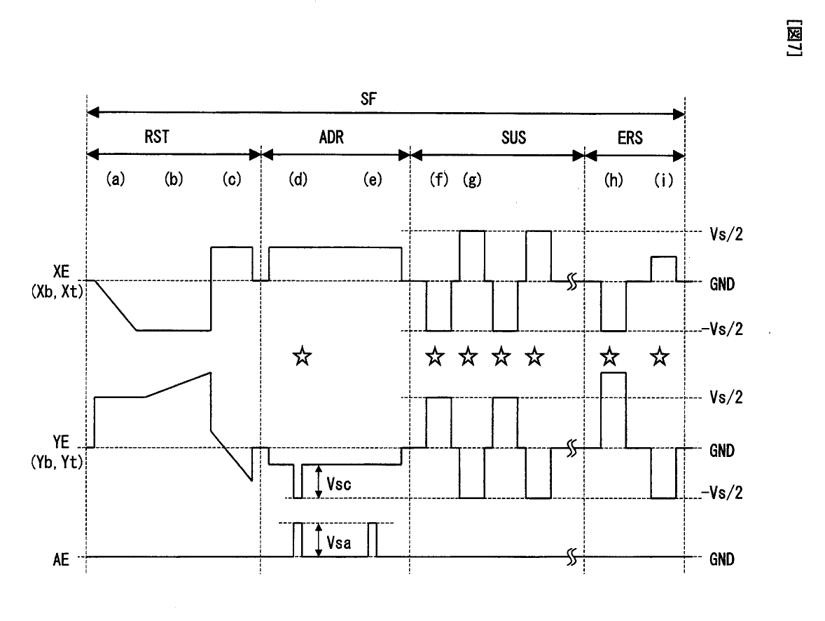

FIG. 7 shows an example of discharge operation in a subfield for displaying an image on the PDP 10 shown in FIG. 1. Stars in the figure indicate generation of discharge. Each subfield SF includes a reset period RST, an address period ADR, a sustain period SUS, and an erase period ERS. The erase period ERS is a period for generating discharge for reducing wall charges in only lit cells and therefore may be defined being included in the sustain period SUS.

First, in the reset period RST, a negative voltage decreasing gradually (slope pulse) is applied to the sustain electrodes XE (bus electrodes Xb and transparent electrodes Xt), and a positive voltage is applied to the scan electrodes YE (bus electrodes Yb and transparent electrodes Yt) (FIG. 7 (a)). And, the sustain electrodes XE are sustained to a negative write voltage, and a positive write voltage increasing gradually (write slope pulse) is applied to the scan electrodes YE (FIG. 7 (b)). Because of this, positive and negative wall charges are stored in the sustain electrodes XE and the scan electrodes YE, respectively, while suppressing luminescence of the cells. Next, a positive adjusting voltage is applied to the sustain electrodes XE, and a negative adjusting voltage (adjusting slope pulse) is applied to the scan electrodes YE (FIG. 7 (c)). Because of this, the amounts of positive and negative wall charges stored in the sustain electrodes XE and the scan electrodes YE, respectively, decrease, and wall charges in all cells become equal. For example, the positive adjusting voltage is a voltage lower than the voltage Vs/2, and the minimum value of the negative adjusting voltage is a voltage higher than the voltage −Vs/2.

In the address period ADR, a scan voltage becoming an anode at address discharge is applied to the sustain electrodes XE, a scan pulse becoming a cathode at address discharge is applied to the scan electrodes YE, and an address pulse (voltage Vsa) becoming an anode at address discharge is applied to address electrodes AE corresponding to lit cells (FIG. 7 (d)). Cells selected by the scan pulse and the address pulse temporarily discharge.

In other words, a voltage larger than the minimum voltage generating discharge (firing voltage) is applied between the scan electrodes YE and the address electrodes AE, and a voltage smaller than the firing voltage is applied between the sustain electrodes XE and the address electrodes AE. Because of this, when address discharge is generated between the address electrode AE and the scan electrode YE of the cell to which attention is paid, erroneous discharge can be prevented from occurring between the sustain electrode XE of the adjacent cell and the address electrode AE. The second address pulse shown in the address electrode AE waveform is applied to select discharge cells of another display line (FIG. 7 (e)).

In the sustain period SUS, negative and positive sustain pulses are applied to the sustain electrodes XE and the scan electrodes YE, respectively (FIG. 7 (f, g)). Because of this, the discharge states of lit cells are sustained. Sustain pulses which are different in polarity from each other are repeatedly applied to the sustain electrodes XE and the scan electrodes YE, so that discharge of cells lit in the sustain period SUS (sustain discharge) is made repeatedly.

In the erase period ERS, a negative pre-erase pulse and a positive high-voltage pre-erase pulse are applied to the sustain electrodes XE and the scan electrodes YE, respectively, and discharge occurs (FIG. 7 (h)). Because of this, wall charges are stored in the sustain electrodes XE and the scan electrodes YE. At that time, a voltage higher than the voltage Vs/2 is applied to the scan electrodes YE, so that the amount of wall charges stored in the scan electrodes relatively increases. Next, a positive erase pulse and a negative erase pulse are applied to the sustain electrodes XE and the scan electrodes YE, respectively (FIG. 7 (i)). Because of this, discharge occurs, but the difference of voltage values applied between two electrodes is less than the difference of voltage values in the sustain period, so that the amount of wall charges becomes less than that in the sustain period SUS.

As described above, in the first embodiment, the seal material SM is disposed in the shape of a frame in a position more inside than the edge part of the dielectric layer DL1. In other words, the seal material SM is disposed more inside than a position where a step between the dielectric layer DL1 and the glass base FS appears. In addition, the seal material SM is disposed more inside than a position where a step between the dielectric layer DL1 and the dielectric layer DL2 appears. That is, any gap can be prevented from appearing in the joint portion of the seal material SM due to steps between the dielectric layers DL1 and DL2 and the glass base FS. As a result of this, the airtightness of the PDP 10 can be secured and the reliability of the PDP 10 can be prevented from decreasing.

In addition, the edge part of the glass base RS is positioned more inside than the edge parts of the dielectric layers DL1 and DL2. Because of this, the airtightness of the PDP 10 can be secured and the reliability of the PDP 10 can be prevented from decreasing while the work of connection between the electrodes XE, YE, and AE and drive circuits (e.g. the drivers XDRV, YDRV, and ADRV shown in FIG. 6) is prevented from becoming complicated.

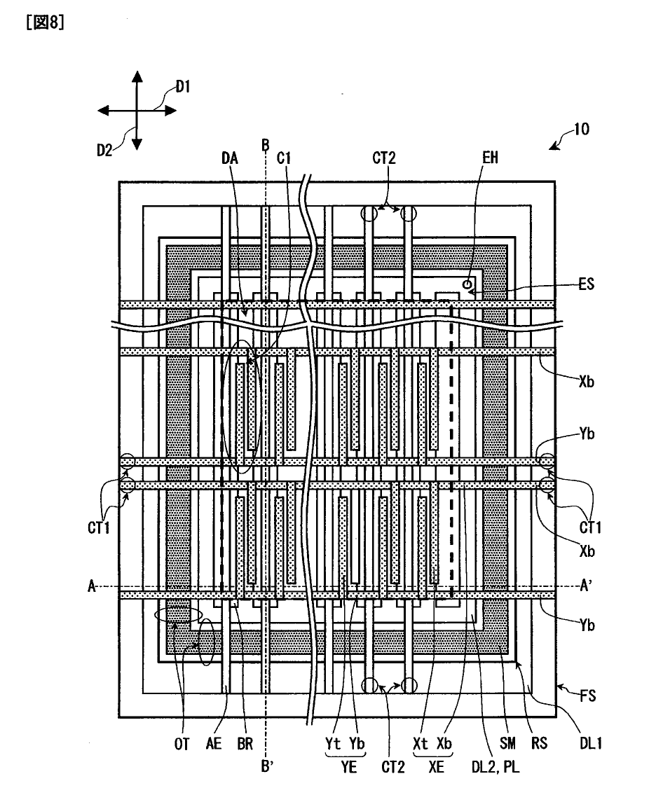

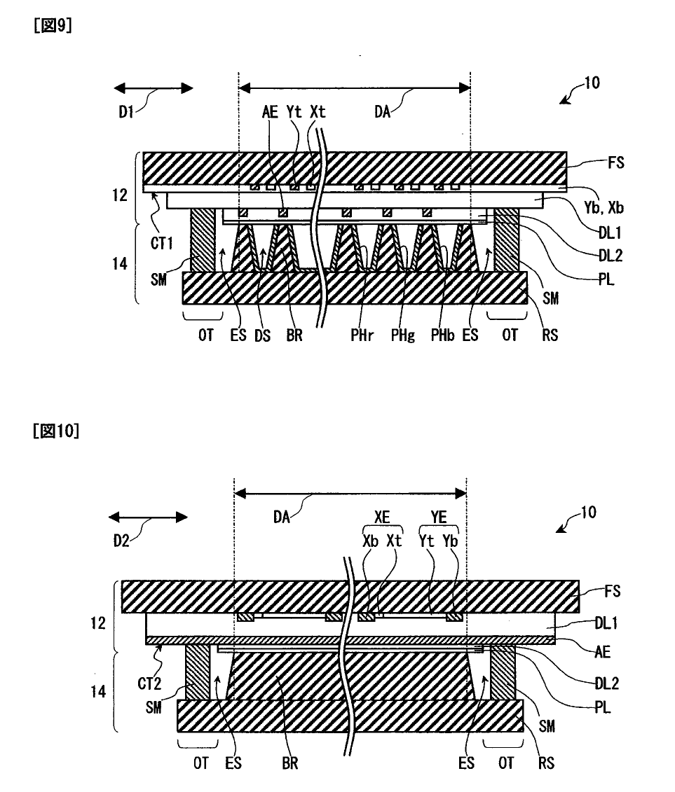

FIGS. 8, 9 and 10 show the outline of a PDP 10 according to the second embodiment of the present invention. FIG. 8 shows a state viewed from the image display surface side (topside in FIG. 9 described above), FIG. 9 shows a cross section taken along the line A-A′ in FIG. 8, and FIG. 10 shows a cross section taken along the line B-B′ in FIG. 8. This embodiment is different from the first embodiment in sizes of a dielectric layer DL2 and a protective layer PL. Other configurations are the same as those of the first embodiment. The same symbols are attached to the same elements as those illustrated in the first embodiment, and detail description thereof is omitted. Furthermore, a PDP device using the PDP 10 of this embodiment and a discharge operation for displaying an image on the PDP 10 are the same as those of the first embodiment (FIGS. 5 to 7).

As shown in FIG. 8, the dielectric layer DL2 and the protective layer PL are disposed more inside than the inner edge part of the seal material SM, and cover the display area DA. The seal material SM is disposed inside the dielectric layer DL1.

As shown in FIGS. 9 and 10, the seal material SM is disposed between the outer surround part OT of the glass base RS of the back plate part 14 and the dielectric layer DL1 of the front plate part 12, and is joined to each of them. For this reason, the step between the dielectric layer DL1 and the glass base FS is positioned outside the seal material SM. Furthermore, the step between the dielectric layer DL1 and the dielectric layer DL2 is positioned between the seal material SM and the display area DA. That is, also in this embodiment, any step can be prevented from appearing in the joint portion of the seal material SM. As a result of this, the airtightness of the PDP 10 can be secured and the reliability of the PDP 10 can be prevented from decreasing. As described above, also in the second embodiment, the same effect as that of the first embodiment described above can be obtained.

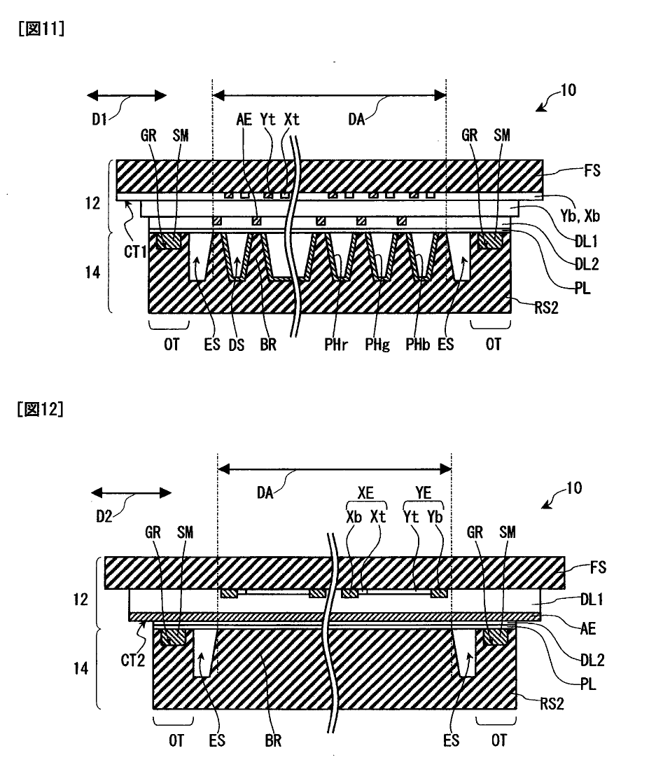

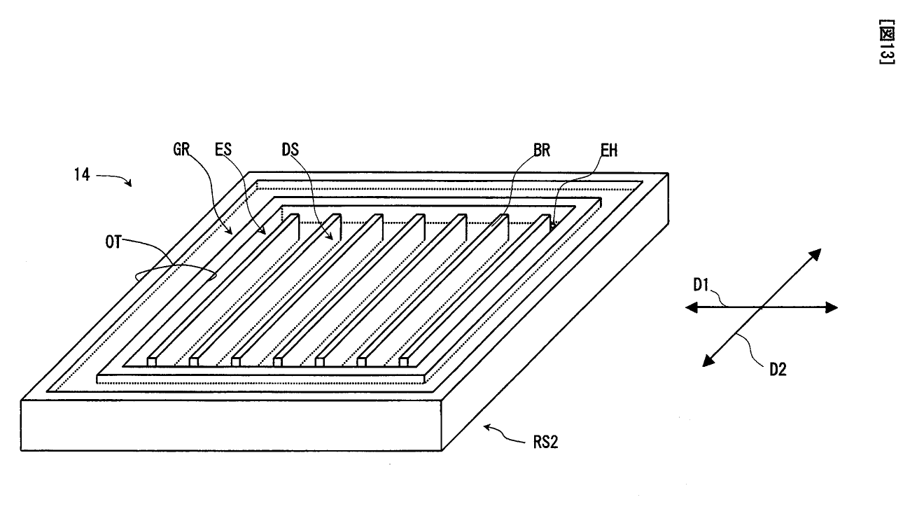

FIGS. 11 and 12 show the outline of a PDP 10 according to the third embodiment of the present invention. FIG. 11 corresponds to the cross section taken along the line A-A′ in FIG. 2 described above, and FIG. 12 corresponds to the cross section taken along the line B-B′ in FIG. 2. This embodiment is different from the first embodiment in that a groove GR is formed on the outer surround part OT of the glass base RS2. Other configurations are the same as those of the first embodiment. The same symbols are attached to the same elements as those illustrated in the first embodiment, and detail description thereof is omitted. Furthermore, a PDP device using the PDP 10 of this embodiment and a discharge operation for displaying an image on the PDP 10 are the same as those of the first embodiment (FIGS. 5 to 7).

A groove GR shaped like a frame is formed on the outer surround part OT of the glass base RS2, and seal material SM is disposed in the groove GR. For example, the discharge spaces DS, the groove GR, and the exhaust space ES are formed by directly engraving the glass base RS2 by a sandblast method or the like. The groove GR is positioned more inside than the dielectric layers DL1 and DL2 and the protective layer PL. That is, the seal material SM is disposed between the groove GR of the back plate part 14 and the protective layer PL of the front plate part 12, and is joined to each of them. Thus, the steps between the dielectric layers DL1 and DL2 and the glass base FS are positioned outside the seal material SM. That is, any step can be prevented from appearing in the joint portion of the seal material SM, and the airtightness of the PDP 10 can be secured. As a result of this, the reliability of the PDP 10 can be prevented from decreasing.

The area of the joint surface between the seal material SM and the front plate part 12 (the protective layer PL in more detail) is made smaller than that of the opening part of the groove GR. In other words, the volume of the seal material SM is smaller than that (capacity) of the groove GR. For this reason, the seal material SM does not overflow the groove GR when the front plate part 12 is adhered to the back plate part 14. As a result of this, any gap by the seal material SM can be prevented from appearing between the barrier ribs BR and the front plate part 12. Since it is possible to get rid of gaps between the barrier ribs BR and the front plate part 12, barrier ribs BR are able to prevent discharge of the cell C1 to which attention is paid from spreading to adjacent cells C1 with the barrier rib BR in between. Thus, erroneous discharge in the adjacent cells C1 can be prevented.

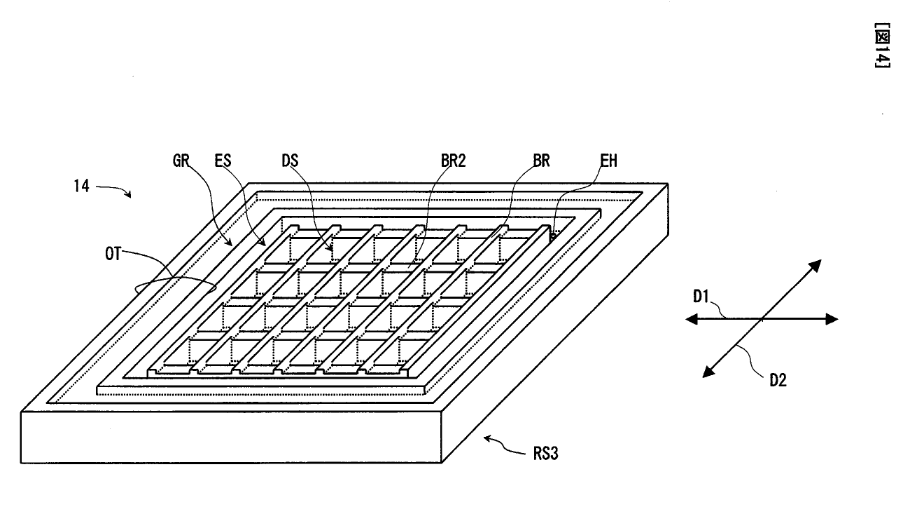

FIG. 13 shows the outline of the back plate part 14 shown in FIG. 1. As described above, the discharge spaces DS, the groove GR, and the exhaust space ES are formed by directly engraving the glass base RS by a sandblast method or the like. In other words, the barrier ribs BR and the groove GR are formed by cutting the glass base RS. Because of this, for example, a baking process for forming the barrier ribs BR is not needed, so that the manufacturing cost of the PDP can be reduced. In many cases, a baking furnace in the baking process uses electricity as energy, and eliminating the baking process results in a reduction in electric energy. The discharge spaces DS may be formed through the processes of coating of paste-state barrier rib material, drying, sandblasting, and baking. Furthermore, the barrier ribs BR may be formed with lamination by printing.

As described above, also in the third embodiment, the same effect as that of the first embodiment described above can be obtained. In other words, the airtightness of the PDP 10 can be secured and the reliability of the PDP 10 can be prevented from decreasing while the work of connection between the electrodes XE, YE and AE and drive circuits (e.g. the drivers XDRV, YDRV and ADRV shown in FIG. 6) is preventing from becoming complicated.

In the above embodiments, an example that one pixel is made up of three cells (red (R), green (G), blue (B)) is described. The present invention is not limited to such an embodiment. For example, one pixel may be made up of four cells or more. Alternatively, one pixel may be made up of cells emitting colors other than red (R), green (G), and blue (B), or one pixel may include cells emitting colors other than red (R), green (G), and blue (B).

In the above embodiments, an example that three kinds of electrodes of the sustain electrode XE, the scan electrode YE, and the address electrodes AE are formed in the front plate part 12 is described. The present invention is not limited to such an embodiment. For example, two kinds of electrodes of the X-electrodes (second electrodes) which also serve as the address electrodes and the scan electrodes YE (first electrodes) may be formed in the front plate part 12. Alternatively, a Z-electrode assisting sustain discharge between the sustain electrode XE and the scan electrode YE may be provided, and four kinds of electrodes of the sustain electrode XE (one kind of first electrodes), the scan electrode YE (one kind of first electrodes), the address electrodes AE (second electrodes), and the Z-electrode (one kind of first electrodes) may be formed in the front plate part 12. In this case also, the same effect as that of the above embodiments can be obtained.

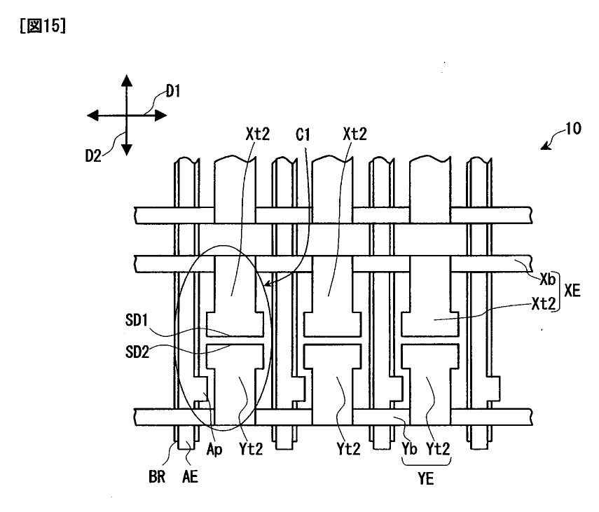

In the above embodiments, an example that the barrier ribs BR are disposed only in positions facing the address electrodes AE is described. The present invention is not limited to such an embodiment. For example, as shown in FIG. 14, barrier ribs BR2 extending in a direction perpendicular to the address electrodes AE may be formed on the glass base RS3. FIG. 14 shows the outline of the back plate part 14 in which the barrier ribs BR2 are formed.

The example of FIG. 14 is different from the third embodiment (FIG. 13) described above in that barrier ribs BR2 are formed on the glass base RS3. Other configurations are the same as those of the third embodiment. The same symbols are attached to the same elements as those illustrated in FIG. 13 described above, and detail description thereof is omitted. In the example of FIG. 14, the barrier ribs BR2 are formed lower than the barrier ribs BR. Because of this, the discharge spaces DS of the assembled PDP 10 can be set to a vacuum state and discharge gas can be encapsulated in the discharge spaces DS, through the exhaust space ES without being interrupted by the barrier ribs BR2.

For example, the barrier ribs BR and BR2 are formed by cutting the glass base RS by a sandblast method or the like. The discharge spaces DS may be formed through the processes of coating of paste-state barrier rib material, drying, sandblasting, and baking. Furthermore, the barrier ribs BR and BR2 may be formed with lamination by printing. In this case also, the same effect as that of the above embodiments can be obtained.

In the above embodiments, an example that the transparent electrodes Xt and Yt are disposed in positions facing each other along the second direction D2 is described. The present invention is not limited to such an embodiment. For example, as shown in FIG. 15, apical ends SD1 and SD2 of transparent electrodes Xt2 and Yt2 may be disposed in positions facing each other along the first direction D1. FIG. 15 shows a state of the electrodes Xb, Xt2, Yb, Yt2, and AE and the barrier ribs BR viewed from the image display surface side. In the example of FIG. 15, the transparent electrodes Xt2 and Yt2 and the address electrodes AE are different from the first embodiment. Other configurations are the same as those of the first embodiment. The same symbols are attached to the same elements as those illustrated in the first embodiment, and detail description thereof is omitted.

The apical ends SD1 of the transparent electrodes Xt2 coupled with the bus electrodes Xb face the apical ends SD2 of the transparent electrodes Yt2 coupled with the bus electrodes Yb. Furthermore, the transparent electrodes Xt2 and Yt2 are each formed in T-shaped to widen the opposed parts. The shape of the transparent electrodes Xt2 and Yt2 may be a rectangle or a trapezoid. Furthermore, projection parts Ap project from the address electrodes AE toward the transparent electrodes Yt2 of their respective cells and are integrally formed with the address electrodes AE. For this reason, address discharge can be generated in the cell C1 to which attention is paid by applying a voltage between the address electrode AE and the transparent electrode Yt2. In this case also, the same effect as that of the above embodiments can be obtained.

In the above embodiments, an example that the edge part of the glass base RS is positioned more inside than the edge part of the dielectric layer DL1 is described. The present invention is not limited to such embodiments. For example, the edge part of the glass base RS on the connection parts CT1 side shown in FIG. 2 described above may be positioned in the same position as the edge part of the dielectric layer DL1. Alternatively, the edge part of the glass base RS on the connection parts CT1 side may be positioned outside the edge part of the dielectric layer DL1 within the range where the work space on the connection parts CT1 is not closed. In this case also, the same effect as that of the above embodiments can be obtained.

In the above embodiments, an example that the edge part of the glass base RS is positioned more inside than the edge part of the dielectric layer DL2 is described. The present invention is not limited to such embodiments. For example, the edge part of the glass base RS may be positioned in the same position as the edge part of the dielectric layer DL2. Alternatively, the edge part of the glass base RS may be positioned outside the edge part of the dielectric layer DL2 within the range where the work space on the connection parts CT1 and CT2 is not closed. In this case also, the same effect as that of the above embodiments can be obtained.

In the third embodiment described above, an example that the seal material SM is disposed in the shape of a frame at a position more inside than the edge part of the dielectric layer DL2 is described. The present invention is not limited to such an embodiment. For example, like the second embodiment described above, the seal material SM may be disposed in the shape of a frame at a position outside the edge part of the dielectric layer DL2. In other words, the dielectric layer DL2 and the protective layer PL may be disposed more inside than the inner edge part of the seal material SM. In this case also, the same effect as that of the third embodiment described above can be obtained.

Although the present invention has been described in detail, the above embodiments and its variations are only examples of the present invention, and the present invention is not limited to them. It should be understood that various modifications can be made without departing from the scope of the present invention.

The many features and advantages of the embodiments are apparent from the detailed specification and, thus, it is intended by the appended claims to cover all such features and advantages of the embodiments that fall within the true spirit and scope thereof. Further, since numerous modifications and changes will readily occur to those skilled in the art, it is not desired to limit the inventive embodiments to exact construction and operation illustrated and described, and accordingly all suitable modifications and equivalents may be resorted to, falling within the scope thereof.

1. A plasma display panel, comprising:
a first plate and a second plate facing each other through a discharge space;
an image display area made up of cells emitting light by a discharge;
a plurality of first electrodes extending in a first direction and disposed at intervals on the first plate;
a first dielectric layer provided on the first plate and covering the display area of the first electrodes;
a plurality of second electrodes extending in a second direction orthogonal to the first direction and disposed at intervals on the first dielectric layer; and
a seal material disposed in a shape of a frame, in order to adhere the second plate to the first plate, at a position more inside than an edge part of the first dielectric layer on an outer surround part of the display area on the second plate.

2. The plasma display panel according to claim 1, wherein
an edge part of the second plate is positioned more inside than the edge part of the first dielectric layer.

3. The plasma display panel according to claim 1, further comprising
a second dielectric layer provided on the first dielectric layer and covering the display area of the second electrodes, wherein
the seal material is disposed at a position more inside than an edge part of the second dielectric layer.

4. The plasma display panel according to claim 3, wherein
the edge part of the second plate is positioned more inside than the edge part of the second dielectric layer.

5. The plasma display panel according to claim 1, further comprising
a second dielectric layer provided on the first dielectric layer and covering the display area of the second electrodes, wherein
the seal material is disposed at a position more outside than an edge part of the second dielectric layer and joined to the first dielectric layer.

6. The plasma display panel according to claim 1, wherein:
each of the second electrodes has a connection part to couple with a circuit applying a voltage to the second electrodes at least at one end part of each of the second electrodes; and
the connection part is disposed outside the seal material and formed on a plane of the first dielectric layer.
